(19) United States
(12) Patent Application Publication
(10) Pub. No.: US 2024/0338703 A1
(43) Pub. Date: Oct. 10, 2024

(54) METHOD, APPARATUS, SYSTEM, AND NON-TRANSITORY COMPUTER READABLE MEDIUM FOR PRESERVING TRADING TIME SERIES

(71) Applicant: Charles Schwab & Co., Inc, San Francisco, CA (US)

(72) Inventors: Logan AHLSTROM, Ann Arbor, MI (US); Jeff FREISTHLER, Ann Arbor, MI (US)

(73) Assignee: Charles Schwab & Co., Inc, San Francisco, CA (US)

(21) Appl. No.: 18/297,936

(22) Filed: Apr. 10, 2023

(51) Int. Cl. G06Q 20/40

(52) U.S. Cl. CPC G06Q 20/4016

(57) ABSTRACT

A system, apparatus, method, and non-transitory computer readable medium for performing co-trading changepoint detection may include a server caused to, receive a transaction dataset, the transaction dataset including a plurality of transactions for analysis, each transaction of the plurality of transactions associated with a user account involved in the transaction, a transaction object involved in the transaction, and transaction timestamp information corresponding to a time of occurrence of the transaction, the user account being one of a plurality of user accounts, generate a first network graph based on the transaction dataset, the first network graph including object nodes and user account nodes representing each of the transactions of the transaction dataset, transform the first network graph into at least one time-dependent transformed graph, and generate at least one potential fraud alert based on results of the network analysis.

### BACKGROUND

### Field

Various example embodiments relate to methods, apparatuses, systems, and/or non-transitory computer readable media for preserving trading time series information in network graphs, and more particularly, methods, apparatuses, systems, and/or non-transitory computer readable media for determining potential victims of fraud, price manipulation, insider trading, and/or other illegal activity based on detection of abnormal trading patterns using trading time series information preserved in network graphs.

### Description of the Related Art

Investors may use brokerage firms and/or security exchanges to execute security trading transactions, such as sales of stocks, bonds, commodities, options, futures, etc. However, the price of securities may be subject to market manipulation, wherein a party may artificially affect the supply or demand for a security, thereby causing the price for the security to dramatically rise or fall. At particular risk for market manipulation are low-priced securities, securities with limited liquidity, and/or securities which have limited publicly available information, such as penny stocks, micro-cap stocks, and new security types (e.g., digital assets, etc.). An example of a market manipulation technique includes pump-and-dump manipulations, wherein one or more parties purchase shares of a security and spread false and/or misleading information regarding the security to artificially increase demand for the security which inflates the price of the security, before selling the security at the artificially inflated price. Other examples of market manipulation techniques include engaging in a series of transactions involving the security to make the security appear more active (e.g., “ramping”), engaging in order spoofing by making numerous transaction orders to move the price of the security before cancelling the spoofed orders, abusing market position to artificially manipulate price (e.g., “market dominance”), etc.

Conventional techniques to detect potentially fraudulent, artificial, and/or illegal market manipulation, such as pumping-and-dumping, ramping, order spoofing, and/or market dominance, etc., relied upon analysis of a limited set of anomaly indicators, such as outsized and/or irregular movements in daily trade price and/or trade volume. Moreover, conventional techniques also focused on analysis of independent account activity. However, these conventional detection techniques suffer from high false-positive rates due to the large volume of security transactions performed on a near daily basis, the number of trading accounts and the number of securities being traded, and the difficulties in detecting artificial changes in security transaction behavior from natural changes and/or legal changes in security transaction behavior, such as pricing changes reflecting increased transactions which are in response to company earnings-related news, pricing changes corresponding to regulatory and/or legal announcements affecting the security, pricing changes corresponding to national events and/or world events affecting the security, etc.

Accordingly, an approach is desired that provides improved, more efficient, and/or more accurate detection of artificial market manipulation of securities. Additionally, an approach is desired to identify potential victims of artificial market manipulation and/or identify the parties perpetrating artificial market manipulation.

### SUMMARY

At least one example embodiment relates to a server.

In at least one example embodiment, the server may include a memory storing computer readable instructions, and processing circuitry configured to execute the computer readable instructions to cause the server to, receive a transaction dataset, the transaction dataset including a plurality of transactions for analysis, each transaction of the plurality of transactions associated with a user account involved in the transaction, a transaction object involved in the transaction, and transaction timestamp information corresponding to a time of occurrence of the transaction, the user account being one of a plurality of user accounts, generate a first network graph based on the transaction dataset, the first network graph including object nodes and user account nodes representing each of the transactions of the transaction dataset, transform the first network graph into at least one time-dependent transformed graph, perform network analysis on the at least one time-dependent transformed graph, and generate at least one potential fraud alert based on results of the network analysis.

Some example embodiments provide that the processing circuitry is further configured to execute the computer readable instructions to cause the server to transform the first network graph into the at least one time-dependent transformed graph by, determining object similarity scores associated with each object node of the first network graph using a weighting based on the transaction timestamp information, and generating the at least one time-dependent transformed graph based on the determined object similarity scores.

Some example embodiments provide that the weighting of the determined object similarity scores includes using an exponential decay function, and the processing circuitry is further configured to execute the computer readable instructions to cause the server to transform the first network graph into the at least one time-dependent transformed graph by, generating the at least one time-dependent transformed graph based on the weighted object similarity scores.

Some example embodiments provide that the processing circuitry is further configured to execute the computer readable instructions to cause the server to transform the first network graph into the at least one time-dependent transformed graph by, determining account similarity scores associated with each account node of the first network graph using a weighting based on the transaction timestamp information, and generating the at least one time-dependent transformed graph based on the determined account similarity scores.

Some example embodiments provide that the weighting of the determined account similarity scores includes using an exponential decay function, and the processing circuitry is further configured to execute the computer readable instructions to cause the server to transform the first network graph into the at least one time-dependent transformed graph by, generating the at least one time-dependent transformed graph based on the weighted account similarity scores.

Some example embodiments provide that the processing circuitry is further configured to execute the computer readable instructions to cause the server to perform the network analysis on the at least one time-dependent transformed graph by, sampling sequences of the at least one time-dependent transformed graph to determine a plurality of clusters of the at least one time-dependent transformed graph, identifying at least one outlier cluster from the plurality of clusters based on at least one fraud indicator, and generating the at least one potential fraud alert based on the identified at least one outlier cluster.

Some example embodiments provide that the processing circuitry is further configured to execute the computer readable instructions to cause the server to perform the network analysis on the at least one time-dependent transformed graph by, detecting communities within the at least one time-dependent transformed graph to determine a plurality of clusters of the at least one time-dependent transformed graph, identifying at least one outlier cluster from the plurality of clusters based on at least one fraud indicator, and generating the at least one potential fraud alert based on the identified at least one outlier cluster.

Some example embodiments provide that the processing circuitry is further configured to execute the computer readable instructions to cause the server to, filter the at least one time-dependent transformed graph based on desired demographic information associated with each user account node of the at least one time-dependent transformed graph, and perform the network analysis on the filtered at least one time-dependent transformed graph.

Some example embodiments provide that the server is further configured to execute the computer readable instructions to cause the server to, receive at least one potential fraud alert trigger, the at least one potential fraud alert trigger indicating at least one of, a price breach alert, a volume breach alert, a desired threshold gain/loss alert, a co-traded object alert, or any combinations thereof, filter the transaction dataset based on the received at least one potential fraud alert trigger, and generate the first network graph based on the filtered transaction dataset.

Some example embodiments provide that the server is further configured to execute the computer readable instructions to cause the server to, transmit the at least one potential fraud alert to at least one of the user account associated with the potential fraud alert, a fraud investigation service, a government agency, or any combinations thereof.

At least one example embodiment relates to a method of operating a server.

In at least one example embodiment, the method may include, receiving a transaction dataset, the transaction dataset including a plurality of transactions for analysis, each transaction of the plurality of transactions associated with a user account involved in the transaction, a transaction object involved in the transaction, and transaction timestamp information corresponding to a time of occurrence of the transaction, the user account being one of a plurality of user accounts, generating a first network graph based on the transaction dataset, the first network graph including object nodes and user account nodes representing each of the transactions of the transaction dataset, transforming the first network graph into at least one time-dependent transformed graph, performing network analysis on the at least one time-dependent transformed graph, and generating at least one potential fraud alert based on results of the network analysis.

Some example embodiments provide that the transforming the first network graph into the at least one time-dependent transformed graph further includes, determining object similarity scores associated with each object node of the first network graph using a weighting based on the transaction timestamp information, and generating the at least one time-dependent transformed graph based on the determined object similarity scores.

Some example embodiments provide that the weighting the determined object similarity scores includes using an exponential decay function, and the transforming the first network graph into the at least one time-dependent transformed graph further includes, generating the at least one time-dependent transformed graph based on the weighted object similarity scores.

Some example embodiments provide that the transforming the first network graph into the at least one time-dependent transformed graph further includes, determining account similarity scores associated with each account node of the first network graph using a weighting based on the transaction timestamp information, and generating the at least one time-dependent transformed graph based on the determined account similarity scores.

Some example embodiments provide that the weighting the determined account similarity scores includes using an exponential decay function, and the transforming the first network graph into the at least one time-dependent transformed graph further includes, generating the at least one time-dependent transformed graph based on the weighted account similarity scores.

Some example embodiments provide that the performing the network analysis on the at least one time-dependent transformed graph further includes, sampling sequences of the at least one time-dependent transformed graph to determine a plurality of clusters of the at least one time-dependent transformed graph, identifying at least one outlier cluster from the plurality of clusters based on at least one fraud indicator, and generating the at least one potential fraud alert based on the identified at least one outlier cluster.

Some example embodiments provide that the performing the network analysis on the at least one time-dependent transformed graph further includes, detecting communities within the at least one time-dependent transformed graph to determine a plurality of clusters of the at least one time-dependent transformed graph, identifying at least one outlier cluster from the plurality of clusters based on at least one fraud indicator, and generating the at least one potential fraud alert based on the identified at least one outlier cluster.

Some example embodiments provide that the method may further include, filtering the at least one time-dependent transformed graph based on desired demographic information associated with each user account node of the at least one time-dependent transformed graph, and performing the network analysis on the filtered at least one time-dependent transformed graph.

Some example embodiments provide that the method may further include, receiving at least one potential fraud alert trigger, the at least one potential fraud alert trigger indicating at least one of, a price breach alert, a volume breach alert, a desired threshold gain/loss alert, a co-traded object alert, or any combinations thereof, filtering the transaction dataset based on the received at least one potential fraud alert trigger, and generating the first network graph based on the filtered transaction dataset.

Some example embodiments provide that the method may further include, transmitting the at least one potential fraud alert to at least one of the user account associated with the potential fraud alert, a fraud investigation service, a government agency, or any combinations thereof.

At least one example embodiment relates to a non-transitory computer readable medium storing computer readable instructions.

In at least one example embodiment, the computer readable instructions, which when executed by processing circuitry of a server, may cause the server to, receive a transaction dataset, the transaction dataset including a plurality of transactions for analysis, each transaction of the plurality of transactions associated with a user account involved in the transaction, a transaction object involved in the transaction, and transaction timestamp information corresponding to a time of occurrence of the transaction, the user account being one of a plurality of user accounts, generate a first network graph based on the transaction dataset, the first network graph including object nodes and user account nodes representing each of the transactions of the transaction dataset, transform the first network graph into at least one time-dependent transformed graph, perform network analysis on the at least one time-dependent transformed graph, and generate at least one potential fraud alert based on results of the network analysis.

Some example embodiments provide that the server is further caused to transform the first network graph into the at least one time-dependent transformed graph by, determining object similarity scores associated with each object node of the first network graph using a first weighting based on the transaction timestamp information, determining account similarity scores associated with each account node of the first network graph using a second weighting based on the transaction timestamp information, wherein the first weighting and the second weighting includes weighting the object similarity scores and the account similarity scores using an exponential decay function, and generating the at least one time-dependent transformed graph based on the weighted object similarity scores and the weighted account similarity scores.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a system associated with an online trading platform according to at least one example embodiment;

FIG. 2 illustrates a block diagram of an example computing device of the online trading platform according to at least one example embodiment;

FIG. 3 illustrates a first example method for detecting abnormal trading patterns using trading time series information preserved in network graphs according to at least one example embodiment;

FIG. 4A illustrates a raw transaction network graph including time series information network graph according to at least one example embodiment;

FIG. 4B illustrates example time-dependent transformed network graphs according to at least one example embodiment;

FIG. 4C illustrates an example combined time-dependent transformed network graph according to FIG. 4B; and

FIG. 4D illustrates a network graph with identified outlier transactions according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

At least one example embodiment refers to methods, systems, devices, and/or non-transitory computer readable media for detecting abnormal trading patterns using trading time series information preserved in network graphs, e.g., determining potentially fraudulent and/or potentially fraudulent price manipulation, pump-and-dump activity, etc. The example embodiments provide improvement over conventional securities transaction fraud detection by performing holistic analysis security transactions and analyzing transaction data involving two or more securities and/or accounts over a desired time period to detect and/or determine suspicious trading cohorts (e.g., suspicious co-trades and/or suspicious co-tuples, etc.). Common account attributes (e.g., common age of investors, common experience level of investors, common geographical locations, common user information, common contact information, etc.) and/or common security attributes (e.g., common industry, common sector, common security classification, etc.), may additionally be used to improve the accuracy of abnormal trading pattern detection and/or reduce false-positive detection rates over conventional detection techniques.

It has been discovered that artificial price manipulators typically attempt to manipulate the price of a plurality of securities during a common and/or same time period (e.g., perform “pump-and-dump” schemes targeting the stocks of two or more penny stocks, microcap stocks, etc.), based on their analysis of previously identified behavior of artificial price manipulators. Consequently, the detection rate of artificial price manipulation may be significantly improved by analyzing the trading behavior of co-traded securities and/or analyzing the trading behavior of cohorts of similar-behaving investor accounts (e.g., investor accounts trading the same set of securities around the same period of time, etc.), instead of analyzing the trading behavior of single securities and/or analyzing the trading behavior of individual trading accounts, and then further identifying potential factors which may have contributed to legal and/or natural changes to the price of the security.

Additionally, due to the large volume of security transactions, number of securities, and/or number of investor accounts, it is mathematically and computationally taxing to perform such analysis for every potential co-trading group of securities and/or every potential cohort of commonly trading investor accounts. As an example, for microcap stocks there are approximately 10,000 microcap stocks available, the inventors observed that approximately hundreds of thousands of user accounts (e.g., 10⁵ accounts) made a few million microcap trades (e.g., 10⁶ transactions) over a six-month time period. Accordingly, the transaction dataset would contain approximately 10¹⁴ data items to be analyzed for a six-month time period. Further, if the dataset were expanded to include all publicly traded securities, the transaction dataset would contain approximately 10¹⁸ data items to be analyzed (e.g., 10⁷ user accounts×10⁸ transactions×10³ securities) for a six-month time period. Moreover, the size of the security transactions dataset inhibits and/or prohibits the performance of sophisticated network graph analysis, such as community detection and/or outlier detection, etc., due to computer resource and/or computer performance constraints.

Accordingly, it is desired to provide a method of reducing the complexity of the transactional dataset by providing a network graph where multi-dimensional connectivity may reveal and/or identify suspicious behavior by revealing relationships which may be undetected in a tabular and/or relational database setting and/or may require analysts to review data stored on different databases, spreadsheets, user interfaces, computer systems, etc. However, traditional network graphs discard the time-ordering of data, and also do not reduce the size and/or complexity of the underlying dataset. Accordingly, an improved and/or transformed network graph is provided which provide account-account and/or stock-stock relationships which may be based on and/or dependent upon transaction time information, thereby reducing thousands or possibly millions of stock-stock and/or account-account relationships to a single edge whose weight represents time-dependency. Additionally, the transformed network graph according to one or more example embodiments provides a unified user interface allowing analysts to view a network visualization of the combined and reduced dataset, thereby eliminating the need to review multiple different datasets on different databases, spreadsheets, user interfaces, computer systems.

Further, the inventors have observed that conventional rule-based fraud detection systems result in a greater than 99% false positive rates. However, the inventors' study using the transformed network graph of one or more of the example embodiments resulted in at least a 3.5× improvement on the conversion rate of anti-money laundering (AML) cases over conventional rule-based fraud detection systems, resulting in a false positive rate of approximately 28%.

Then, according to at least one example embodiment, information associated with the suspicious trading activity, such as information regarding the user accounts involved in the suspicious trades, the transaction data itself, etc., may be forwarded to fraud investigators, law enforcement, and/or security regulators, etc., for further investigation and/or analysis. Additionally, according to some example embodiments, a search and/or investigation (e.g., an automated search and/or investigation) may be performed for external factors associated with the identified securities which may have caused and/or impacted the increased suspicious trading activity, etc., during the relevant time period(s) corresponding to the determined changepoints, such as company press releases affecting the stock price, regulatory changes affecting the relevant industry, etc., to further reduce potential false positive identifications, etc.

Moreover, at least one example embodiment provides methods, systems, devices, and/or non-transitory computer readable media for determining potential victims and/or perpetrators of artificial price manipulation based on the detection of suspicious trading activity and/or potential artificial market manipulation. Additionally, according to at least some example embodiments, the detection of anomalous trading cohorts and/or potential artificial price manipulation behavior may be performed on historical data stored on the online trading platform and/or may be performed in real-time and/or near real-time on incoming trading transactions processed by the online trading platform, etc., but the example embodiments are not limited thereto. Further, according to some example embodiments, the detection of anomalous trading cohorts and/or potential artificial price manipulation behavior may be performed on an “online” and/or streaming basis, wherein the analysis is performed on new data as the new data arrives, without re-calculating previous analysis, etc., or in other words, the analysis may be performed on trading transaction data corresponding to sliding time windows, etc.

While the various example embodiments of the present disclosure are discussed in connection with an online brokerage platform and the trading of penny stocks and/or microcap stocks (e.g., stocks for companies that have a market capitalization between $50 million and $300 million) for the sake of clarity and convenience, the example embodiments are not limited thereto, and one of ordinary skill in the art would recognize the example embodiments may be applicable to other types of securities (e.g., bonds, commodities, options, etc.), other size categories and/or sector categories of securities (e.g., mid-cap stocks, large-cap stocks, international stocks, growth stocks, mutual funds, exchange traded funds (ETFs), etc.), other transaction platforms (e.g., stock exchanges, commodities exchanges, etc.), and/or other types of transactions (e.g., short sales, margin purchases, futures contracts, etc.), but the example embodiments are not limited thereto. Additionally, the example embodiments are not limited to the detection of anomalous trading cohorts and/or potentially fraudulent activity in securities trading activity, and may be applied to other technological fields, such as the detection of anomalous user cohorts and/or fraudulent (and/or potentially) fraudulent computer network activity (e.g., hacking and/or phishing attacks on online computer networks and/or online user accounts, etc.), the detection of fraudulent and/or potentially fraudulent banking and/or credit card activity, the detection of anomalous user cohorts fraudulent (and/or potentially fraudulent) social media activity (e.g., coordinated misinformation and/or disinformation campaigns), etc., and/or other fields wherein transaction data and/or activity data are stored and the stored data includes time information corresponding to the data. The example embodiments may provide similar benefits of reducing false positive rates, improving computational efficiency, reducing hardware resource usage, etc., to these additional technology fields.

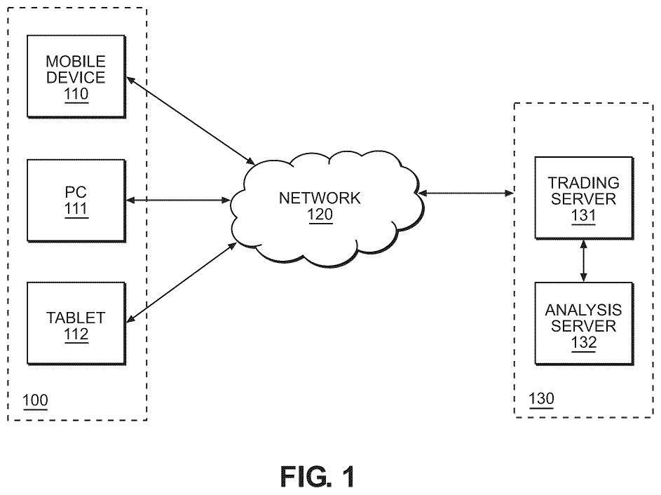

FIG. 1 illustrates a system associated with an online trading platform according to at least one example embodiment. As shown in FIG. 1, the online trading platform system includes a plurality of user devices 100 including a mobile device 110, a personal computer 111, and a tablet 112, etc., a network 120, and at least one server 130 associated with the online trading platform, but the example embodiments are not limited thereto, and the example embodiments may include a greater or lesser number of constituent elements. According to at least one example embodiment, the server 130 may host and/or provide functionality of at least a portion of a desired brokerage firm and/or security exchange, etc., and may include a trading server 131 for receiving security transaction requests (e.g., buy orders, sell orders, security research requests, etc.) from at least one user of the online trading platform, and an analysis server 132 for performing analysis on records of securities transaction of desired sets of securities and/or users to detect manipulation due to fraud, etc. According to some example embodiments, the trading server 131 and the analysis server 132 may be implemented in a single server, or one or more of the trading server 131 and/or the analysis server 132 may be implemented as a plurality of servers, etc. Additionally, each of the plurality of user devices 100 may allow a respective user to access the online trading platform via the at least one server 130. For example, one or more of the plurality of user devices 100 may have software application(s) (e.g., apps, programs, code, computer readable instructions, etc.) installed and/or may execute software application(s) corresponding to the online trading platform (e.g., the online trading platform client application, etc.), and/or one or more of the plurality of user devices 100 may have installed and/or may execute a web browser application which allows a corresponding user of the user device to access a website for the online trading platform, execute trades on the online trading platform, etc., but the example embodiments are not limited thereto.

According to some example embodiments, the user devices 100 may include computing devices, such as a personal computer (PC), a laptop, a server, a database system, a smartphone, a tablet, any other smart devices, a wearable device, an Internet-of-Things (IoT) device, a virtual reality (VR) and/or augmented reality (AR) device, a virtual assistant device, a Personal Digital Assistant (PDA), etc., but are not limited thereto. Additionally, the plurality of user devices 100 may further include computing devices which may be indirectly accessed by a user of the online trading platform to place securities transactions on behalf of the user, such as the computer of a stockbroker who, for example, receives a phone trade order from the user, etc. Further, the system may include a plurality of additional servers associated with (and/or hosting, implementing, storing transaction data, etc.) the online trading platform and/or additional servers corresponding to other brokerage firms and/or security exchanges, etc. Additionally, the system may include less than three user devices and/or the system may include greater than three user devices, etc.

The plurality of user devices 100 and the server 130 may be connected over the network 120, and the network 120 may correspond to a wireless network, such as a cellular wireless access network (e.g., a 3G wireless access network, a 4G-Long Term Evolution (LTE) network, a 5G-New Radio (e.g., 5G) wireless network, a WiFi network, a satellite network, etc.) and/or a wired network (e.g., a fiber network, a cable network, a PTSN, etc.). The server 130 may connect to other servers (not shown), over a wired and/or wireless network, and each of the user devices 110, 111, and/or 112 may connect to other user devices over a wired and/or wireless network. The network 120 may refer to the Internet, an intranet, a wide area network, etc.

While certain components of a system associated with an online trading platform are shown in FIG. 1, the example embodiments are not limited thereto, and the system may include components other than that shown in FIG. 1, which are desired, necessary, and/or beneficial for operation of the underlying networks within the system, such as base stations, access points, switches, routers, nodes, servers, gateways, etc.

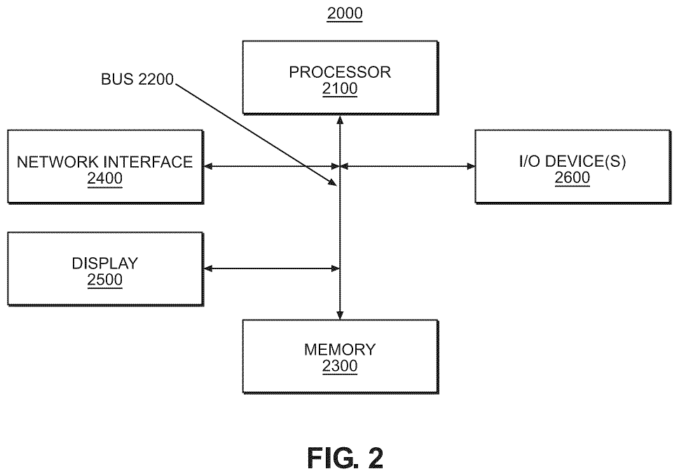

FIG. 2 illustrates a block diagram of an example computing device of the online trading platform according to at least one example embodiment. The computing device 2000 of FIG. 2 may correspond to the server 130, the trading server 131, the analysis server 132, and/or one or more of the plurality of user devices 100 of FIG. 1, but the example embodiments are not limited thereto.

Referring to FIG. 2, a computing device 2000 may include processing circuitry, such as the at least one processor 2100, at least one communication bus 2200, a memory 2300, at least one network interface 2400, and/or at least one input/output (I/O) device 2500 (e.g., a keyboard, a touchscreen, a mouse, a microphone, a camera, a speaker, etc.), etc., but the example embodiments are not limited thereto. For example, the computing device 2000 may further include a display panel 2500, such as a monitor, a touchscreen, etc. The memory 2300 may include various special purpose program code including computer executable instructions which may cause the computing device 2000 to perform one or more of the methods of the example embodiments, including but not limited to computer executable instructions related to an online trading platform, a trained neural network for generating and transforming network graphs and performing network analysis on time-dependent network graphs, a security transaction database associated with the online trading platform and/or the trained neural network, etc.

In at least one example embodiment, the processing circuitry may include at least one processor (and/or processor cores, distributed processors, networked processors, etc.), such as the at least one processor 2100, which may be configured to control one or more elements of the computing device 2000, and thereby cause the computing device 2000 to perform various operations. The processing circuitry (e.g., the at least one processor 2100, etc.) is configured to execute processes by retrieving program code (e.g., computer readable instructions) and data from the memory 2300 to process them, thereby executing special purpose control and functions of the entire computing device 2000. Once the special purpose program instructions are loaded into, (e.g., the at least one processor 2100, etc.), the at least one processor 2100 executes the special purpose program instructions, thereby transforming the at least one processor 2100 into a special purpose processor.

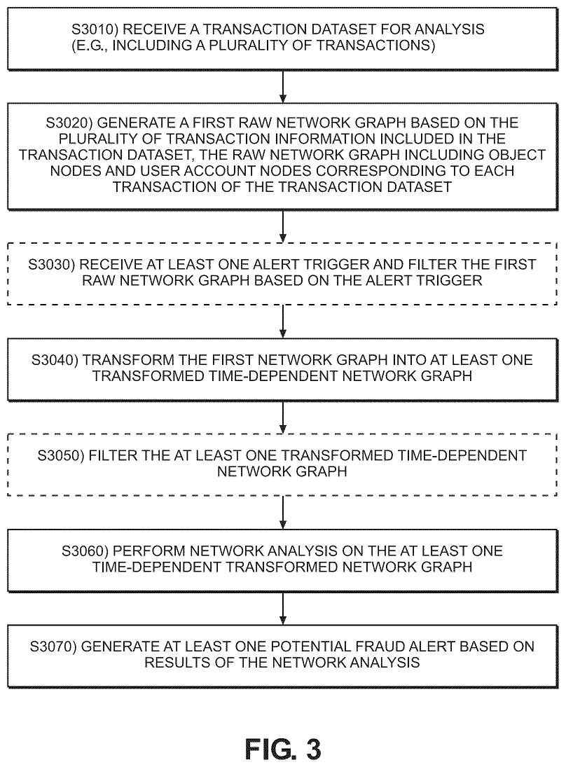

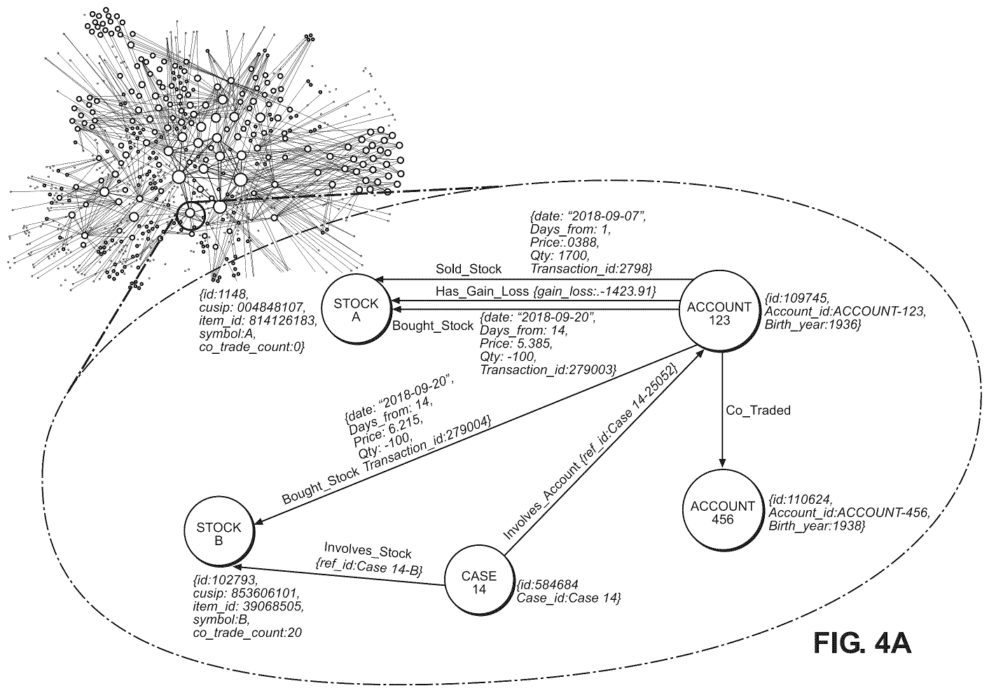

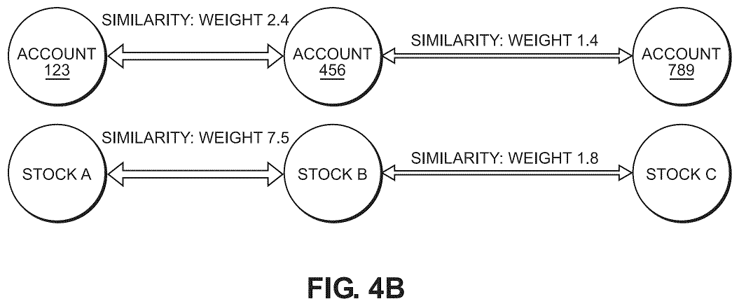

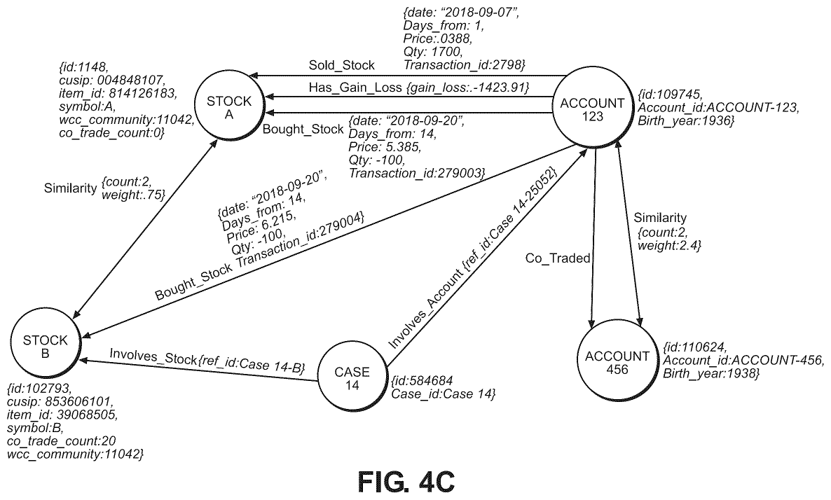

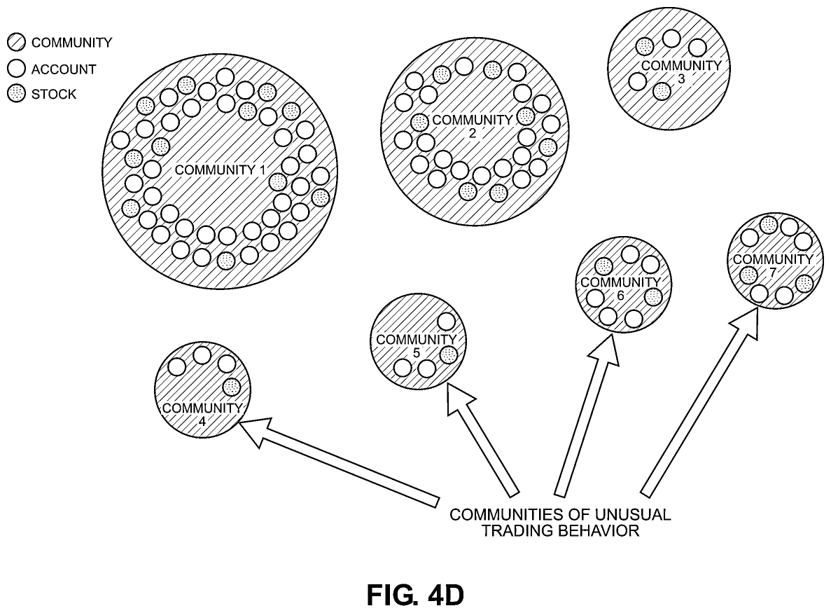

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the online trading platform (e.g., the network graph analysis service, a database for storing raw security transaction data, trading platform user account information, etc.) and/or the computing device 2000, such as the methods discussed in connection with FIGS. 3 to 4D, the at least one network interface 2400, and/or at least one I/O device 2500, etc. Such software elements may be loaded from a non-transitory computer-readable storage medium independent of the memory 2300, using a drive mechanism (not shown) connected to the computing device 2000, or via the at least one network interface 2400, and/or at least one I/O device 2500, etc.

In at least one example embodiment, the at least one communication bus 2200 may enable communication and/or data transmission to be performed between elements of the computing device 2000. The bus 2200 may be implemented using a high-speed serial bus, a parallel bus, and/or any other appropriate communication technology. According to some example embodiments, the computing device 2000 may include a plurality of communication buses (not shown).

The computing device 2000 may be associated with an online trading platform and may operate as, for example, a trading server, a brokerage server, a financial services server (e.g., banking services, loan services, etc.), an analysis server, a web server, a messaging server, a search server, a news server, etc., or any combinations thereof, and may be configured to provide security trading services and/or financial services to at least one user of the online trading platform. Additionally, the computing device 2000 may also provide communication and/or messaging services for the one or more users of the online trading platform which allows users of the online trading platform to contact and/or message one or more other users of the online trading platform via the computing device 2000. For example, the computing device 2000 may also provide an online community (e.g., a forum, a website, a portal, a discussion board, an investment advisor service, a fraud investigation service, a group chat service, a teleconference service, a videoconference service, etc.) wherein users of the online trading platform may transmit messages for employees of the online trading platform, such as brokerage advisors, financial advisors, IT administrators, fraud investigators, etc., security regulators, law enforcement officers, other users of the online trading platform, or a subset of the users of the online trading platform. Moreover, the online trading platform may provide one or more sections and/or areas dedicated to different categories of interest to the users (e.g., security topics, trading advice, financial news, political news, national/world news, etc.).

According to at least one example embodiment, the computing device 2000 may host an online trading platform providing users with the ability to perform securities transactions, e.g., purchases and/or sales of stocks, purchase and/or sales of options contracts, obtaining loans for purchasing stocks, etc., but are not limited thereto, and for example, the online trading platform is not limited to stocks, and may include other classes and/or categories of securities, other classes and/or categories of transactions, etc. The online trading platform may generate network graphs and perform network analysis on the generated network graphs to detect anomalous trading cohorts and/or potential artificial market manipulation in the price of co-traded securities, by generating a raw network graph corresponding to a plurality of trading transactions, the raw network graph including object nodes representing individual securities and user account nodes representing individual user accounts from at least one raw trading transaction dataset stored on the online trading platform, etc., transforming the raw network graph into at least one time-dependent transformed graph, the transforming including determining similarity scores and/or performing time-dependent weighting on the transactions included in the raw network graph, performing network analysis on the at least one time-dependent transformed graph to identify outlier communities and/or outlier nodes within the at least one time-dependent transformed graph, and then generating at least one potential fraud alert based on the identified outlier communities and/or outlier nodes. The methods for performing the detection of anomalous trading cohorts and/or potential artificial market manipulation according to some example embodiments will be discussed in further detail in connection with FIGS. 3 to 4D.

While FIG. 2 depicts an example embodiment of a computing device 2000, the computing device 2000 is not limited thereto, and may include additional and/or alternative architectures that may be suitable for the purposes demonstrated. For example, the functionality of the computing device 2000 may be divided among a plurality of physical, logical, and/or virtual server and/or computing devices, network elements, etc.

FIG. 3 illustrates a first example method for detecting abnormal trading patterns using trading time series information preserved in network graphs according to at least one example embodiment. FIG. 4A illustrates a raw transaction network graph including time series information network graph according to at least one example embodiment. FIG. 4B illustrates example time-dependent transformed network graphs according to at least one example embodiment. FIG. 4C illustrates an example combined time-dependent transformed network graph according to FIG. 4B. FIG. 4D illustrates a network graph with identified outlier transactions according to at least one example embodiment.

Referring now to FIG. 3, according to at least one example embodiment, in operation S3010, a server, such as the analysis server 132 of FIG. 1, may receive and/or obtain at least one raw security transaction dataset (e.g., transaction dataset, etc.) for analysis. In at least one example embodiment, the analysis server 132 may receive the raw transaction dataset from a trading server, such as the trading server 131 of FIG. 1, and/or other transaction server(s) from at least one online trading platform, a brokerage firm, a stock exchange, a banking institution, and/or a governmental regulatory agency (e.g., the Financial Industry Regulatory Authority (FINRA), the U.S. Securities and Exchange Commission (SEC), etc.), but the example embodiments are not limited thereto. The raw dataset may include information and/or data associated with a plurality of raw securities transactions, such as a transaction identifier, a transaction object identifier (e.g., stock ticker symbol, financial institution identifier, etc.), transaction user account information, a transaction type (e.g., stock purchase, stock sale, options contract purchase, options contract sale, etc.), and/or transaction timestamp information (e.g., the date and time the transaction occurred, etc.). The raw dataset may also include additional information, such as transaction price amount (e.g., purchase price, sale price, whether a gain or loss was realized by the transaction, the amount of gain or loss realized by the transaction, number of days between the start of the analysis time period and the date of the transaction, etc.), transaction share quantity (e.g., number of stock shares being transacted, etc.), a transaction object type (e.g., microcap stock, small-cap stock, midcap stock, large-cap stock, international microcap/small-cap/midcap/large-cap stock, mutual fund shares, ETF shares, etc.), etc. According to some example embodiments, the transaction user account information may include purchaser user account information and/or seller user account information, such as the online trading platform user account identifier associated with the purchaser/seller, the real name of the purchaser/seller, the contact information of the purchaser/seller (e.g., mailing address, phone number, email address, etc.), the banking account information associated with the purchaser/seller, the user account type associated with the purchaser/seller (e.g., is the user account a personal account, a retirement account, an institution account, etc.), but are not limited thereto. Additionally, the raw dataset may include information related to active and/or known AML cases (e.g., FINRA cases, SEC cases, etc.), such as one or more user accounts associated with an active and/or known AML case and/or one or more objects associated with an active and/or known AML case, etc. Further, the raw dataset may include information regarding whether two or more accounts have been identified as engaging in co-trading behavior and/or information identifying two or more stocks as being co-traded. Methods, devices, and systems for identifying co-trading accounts and/or co-traded stocks are disclosed in U.S. application Ser. No. 17/894,304, which is incorporated herein in its entirety.

The raw dataset may include raw transaction data over a desired time range (e.g., a week, a month, a fiscal quarter, a fiscal year, a plurality of years, etc.), but is not limited thereto. Additionally, the analysis server 132 may receive and/or obtain new raw transaction data from the trading server 131 at desired time intervals, such as a monthly basis, weekly basis, daily basis, an hourly basis, a per-minute basis, etc.), and/or on a batch transaction basis, such as every hundred transactions, every ten transactions, every transaction, etc. For example, the analysis server 132 may receive the new raw transaction data on a real-time basis from the trading server 131, or on a near real-time basis, but the example embodiments are not limited thereto. Additionally, according to some example embodiments, the trading server 131 and the analysis server 132 may be combined into a single server, etc.

In operation S3020, the analysis server 132 may generate a raw network graph (e.g., a first network graph, etc.) based on the transaction dataset. The generated raw network graph may include a plurality of user account nodes corresponding to the user account(s) associated with each of the transactions included in the transaction dataset. Further, the generated raw network graph may include a plurality of object nodes corresponding to the stocks associated with each of the transactions included in the transaction dataset.

Referring now to FIG. 4A, FIG. 4A represents a generated raw network graph based on a raw transaction dataset. As shown in the FIG. 4A, assuming that the raw transaction dataset includes only microcap stock transactions over a six-month time period, a raw network graph may include approximately 10³ microcap stock nodes, approximately 10⁵ user account nodes, and at least 10⁶ transaction connections for the six-month time period, but the example embodiments are not limited thereto, and for example, a different number and/or category of securities may be analyzed, a different number and/or set of user accounts may be analyzed, a different number of transactions may be analyzed, and/or a different time period for analysis may be selected. Further, as shown in the zoomed-in portion of the raw network graph, the raw network may include a plurality of user account nodes, a plurality of object nodes, and a plurality of connections between user accounts nodes and object nodes corresponding to transactions performed during the desired and/or selected time period for analysis. For example, the user account node “Account-123” is connected to the object node “Stock-A” 2 times, and the object node “Stock-B” one time. Additionally, the user account node “Account-456” is connected to the user account node “Account-123” because the two user accounts have been identified as being co-trading accounts. Further, the user account node “Account-123” is connected to the “Case 14” case node once which involves the stock “Stock-B.” Moreover, as shown in FIG. 4A, each connection between user account node and object node includes additional information corresponding to and/or associated with each individual transaction, such as the transaction timestamp information, the transaction type, purchase price, sale price, purchase quantity, sales quantity, whether a gain or loss was realized, an amount of gain or loss realized, etc., but the example embodiments are not limited thereto. For example, additional transaction information may be included in each connection and/or edge of the raw network graph, such as co-trading count (e.g., the number of other stocks with which this stock is co-traded and/or the number of other user accounts with which this user account co-trades with, etc.), demographic information associated with the user account (e.g., age/birth year of the user, geographic location of the user, income level of the user, etc.), user account type (e.g., a tax deferred user account type, a retirement user account type, a taxable brokerage account type, etc.), a security type (e.g., stocks, bonds, options, etc.), a size category of the security (e.g., large cap, medium cap, small cap, microcap, domestic or foreign, etc.), a sector and/or industry of the security (e.g., consumer sector, tech sector, energy sector, etc.), etc. As can be appreciated when viewing FIG. 4A, the raw network graph may be too large for manual review by government securities regulators, law enforcement, and/or financial crimes investigators, etc.

Referring again to FIG. 3, in optional operation S3030, the analysis server 132 may receive alert triggers from an external source, such as the trading server 131, a government regulation agency, etc., and may filter the at least one transformed time-dependent network graph based on the alert trigger. For example, the trigger alert may be an alert related to a price breach for a particular security and/or a class of security, etc., a volume breach for a particular security and/or a class of security, etc., and/or for a particular user account, etc., a desired threshold gain/loss alert, a co-traded object alert (e.g., an alert generated based on changepoint detection of potential fraudulent transaction activity), etc., but the example embodiments are not limited thereto. Accordingly, the analysis server 132 may filter the raw network graph (and/or the raw transaction dataset) based on the account information and/or security information contained in the alert trigger, to reduce the number of transactions to be analyzed. However, in other example embodiments, a trigger alert may not have been received by the analysis server 132 and the analysis server 132 may omit the filtering of the raw network graph and/or may filter the raw network graph based on other inputs, such as user inputs designating, selecting, and/or indicating one or more desired filtering criteria, such as a date range, at least one user demographic setting (e.g., age of the user, geographic location of the user, income level of the user, gender of the user, etc.), user account type (e.g., filter based on whether the user account type is a tax deferred and/or retirement user account type; filter based on whether the user account type is a taxable brokerage account, filter based on whether the user account type is a college savings account, etc.), a security type (e.g., stocks, bonds, options, etc.), a size category of the security (e.g., large cap, medium cap, small cap, microcap, etc.), a sector and/or industry of the security (e.g., consumer sector, tech sector, energy sector, etc.), but the example embodiments are not limited thereto.

In operation S3040, the analysis server 132 may transform the raw network graph into one or more transformed time-dependent network graphs. More specifically, the analysis server 132 may transform the raw network graph into stock-stock and/or account-account relationships that are based on and/or dependent on the similarity of the transactions and the recency of the underlying transactions (e.g., weighted based on time-ordering), etc. The analysis server 132 may determine stock similarity scores (in other words, determine how similar two or more stocks are to each other) based on the commonality of user accounts which have traded and/or transacted in each of the stocks in the stock cohort. Additionally, the analysis server 132 may determine account similarity scores (in other words, determine how similar two or more stocks are to each other) based on the commonality of stocks which have been traded and/or transacted by each of the user accounts in an account cohort.

Optionally, the analysis server 132 may also determine stock centrality scores for each of the stocks included in the raw network graph, wherein the centrality score indicates the importance of the given node to the network. More specifically, the analysis server 132 may determine stock centrality scores for one or more of the stock nodes of the raw network graph based on, for example, the number of accounts which traded the stock, the total transaction amount from trades on the stock, etc., wherein the higher number of accounts and/or the higher transaction amounts equate to a higher stock centrality score. Further, the analysis server 132 may also determine centrality scores for each user account included in the raw network graph. The account centrality scores may be represented by the total number of stocks traded by the account, the total transaction amount associated with the account, etc., wherein a higher number of total number of stocks traded and/or a higher total transaction amount equate to a higher account centrality score.

According to some example embodiments, the analysis server 132 may determine and/or calculate the similarity scores by using the following time-dependent linear exponential decay formula on the transaction data associated with each of the stock-stock cohorts and/or user account-user account cohorts, wherein more recent transactions are given more weight than older transactions. According to at least one example embodiment, a similarity score (s_{ab}) for account-account connections may be calculated using the following weighted pairwise similarity score equation, where the equation scales the relationship strength between the pair of accounts based on the amount of time elapsed between each account trading the individual security (e.g., with the similarity score being higher when the amount of time elapsed between the transactions is lower).

$${s}_{a b} = {\sum }_{i}^{N} {\sum }_{Δ {T}_{a b}} ( x + y {e}^{- λ Δ {T}_{a b} / T} ) \cdot {δ}_{a b} \qquad [ Equation 1 ]$$

Wherein N=the total number of securities in the dataset to be analyzed; i represents an individual security included in the set of securities being analyzed; a and b represent a particular pair of user accounts; and δ_{ab}=1 if security i is traded by both a and b; and δ_{ab}=0 if security i is not traded by both a and b. Optionally, in the event that one of the user accounts a or b are identified as being the focus of and/or involved in an active and/or known AML investigation, etc., δ_{ab} may be set to a desired AML investigation value (e.g., a desired investigation weight, etc.), and δ_{ab} may be set to a higher desired value if both of the user accounts a and b are identified as being the focus of and/or involved in an active and/or known AML investigation, etc. Similarly, δ_{ab} may optionally be set to a desired co-trading value (e.g., a desired co-trading weight, etc.) if user accounts a and b are identified as co-trading accounts, etc. The optional desired AML investigation value and/or optional desired co-trading value may be set based on experiential data, may be user defined value(s), may be set by the analysis server 132, etc.

Additionally, ΔT_{ab} is the length of time between trades of security i by accounts a and b. For example, ΔT_{ab}=0 when the accounts traded the security on the same day. T is the total number of days over the time period in which transactions are analyzed (e.g., 6 months, etc.).

Moreover, x+ye^{-λT}^{_{ab}}^{/T} is the decay function, wherein x and y are constants and i is a tuning parameter which controls the rate of decay, wherein increasing λ leads to λ faster decay. According to one or more example embodiments, the values of x, y, and/or λ may be set, adjusted, and/or configured by the user based on design considerations and/or may be set based on experiential data, etc.

For example, if x=y=1, λ=1, and ΔT_{ab}=0 (e.g., accounts a and b traded stock i on the same day), then the similarity score of accounts a and b is 2.0 in relation to the stock i. The value of the similarity score decreases and/or diminishes to ˜1.367 if the accounts traded the stock i six months apart. Further, the calculated similarity scores are summed across all securities in the dataset for each account pair.

Additionally, according to at least one example embodiment, a similarity score (sᵢⱼ) for security-security connections may be calculated using a similar weighted pairwise similarity score equation. Likewise, the pairwise security similarity score equation scales the relationship strength between the pair of securities based on the amount of time elapsed between when a single account traded the pair of securities, with the similarity score being higher when the amount of time elapsed between the transactions is lower.

$${s}_{i j} = {\sum }_{a}^{A} {\sum }_{Δ {T}_{i j}} ( x + y {e}^{- λ Δ {T}_{i j} / T} ) \cdot {δ}_{i j} \qquad [ Equation 2 ]$$

Wherein A is the total number of accounts in the dataset to be analyzed; i and j represent a particular pair of securities being analyzed; and δᵢⱼ=1 if account a traded both security i and security j; otherwise δᵢⱼ=0. Optionally, in the event that one of the securities i or j are identified as being the focus of and/or involved in an active and/or known AML investigation, etc., δᵢⱼ may be set to a desired AML investigation value (e.g., a desired investigation weight, etc.), and δᵢⱼ may be set to a higher desired value if both of the securities i and j are identified as being the focus of and/or involved in an active and/or known AML investigation, etc. Similarly, δᵢⱼ may optionally be set to a desired co-trading value (e.g., a desired co-trading weight, etc.) if securities i and j are identified as co-traded securities, etc. The optional desired AML investigation value and/or optional desired co-trading value may be set based on experiential data, may be user defined value(s), may be set by the analysis server 132, etc.

Additionally, ΔTᵢⱼ is the amount of time between trades of securities i and j by account a. For example, ΔTᵢⱼ=0 when account a traded the securities i and j on the same day.

Moreover, x+ye^{-λΔT}^{ᵢⱼ}^{/T} is the decay function, wherein x and y are again constants, and λ is the tuning parameter which controls the rate of decay, wherein increasing λ leads to a faster decay. According to one or more example embodiments, the values of x, y, and/or λ may be set, adjusted, and/or configured by the user based on design considerations and/or may be set based on experiential data, etc.

As an example, if x=y=1, λ=1, and ΔTᵢⱼ=0 (e.g., stocks i and j were traded by account a on the same day), then the similarity score of stocks i and j is 2.0 in relation to the account a. The value of the similarity score decreases and/or diminishes to ˜1.367 if the stocks i and j were traded by account a six months apart. Further, the calculated similarity scores are summed across all accounts in the dataset for each security pair.

While equations 1 and 2 are shown comparing a pair of user accounts and a pair of securities, respectively, the example embodiments are not limited thereto, and equations 1 and 2 may be modified to compare transactions involving three or more user accounts and/or three or more securities, etc. Further, while equations 1 and 2 are discussed as measuring the amount of time between trades as being measured using days, the example embodiments are not limited thereto, and other units of time may be used.

According to some example embodiments, the analysis server 132 may filter the account-account pairs and/or the security-security pairs based on a desired, set, and/or configured similarity score threshold to reduce the size of the network graph prior to the transformation of the time-dependent network graph (e.g., the generation of the time-dependent network graph), etc. For example, the network graph may be filtered so that similar account-account pairs and/or security-security pairs with a similarity score of greater than, e.g., 1.0, are included in the transformed time-dependent network graph to reduce the amount of data to be analyzed, reduce the amount of computer resources needed to analyze the data (e.g., perform outlier detection, etc.), and/or to reduce the number of false positive AML cases detected, etc.

However, the example embodiments are not limited thereto, and for example, the analysis server 132 may generate the transformed time-dependent network graph based on only the stock similarity scores, on only the user account similarity scores, and/or both the stock similarity scores and the user account similarity scores.

Referring now to FIG. 4B, the analysis server 132 may generate two or more transformed time-dependent network graphs based on the calculated similarity score(s), but the example embodiments are not limited thereto, and for example, the analysis server 132 may generate a single, combined time-dependent network graphs based on the calculated similarity score(s). As shown in FIG. 4B, Account 123 and Account 456 may have a similarity score of “2.4,” and Account 456 and Account 789 may have a similarity score of “1.4.” Additionally, Stock A and Stock B may have a similarity score of “0.75,” and Stock B and Stock C may have a similarity score of “1.8.” The multi-dimensional relationship between each of the nodes may be further visually represented by the thickness of the connection arrows between node pairs, the coloring of the connection arrows, the length of the connection arrows, etc. For example, the thickness of the connection arrow and/or length of the connection arrow may directly correspond to the similarity score between the nodes (e.g., the thickness and/or the length of the connection arrows being representative of the similarity scores), such that an observer may be able to immediately determine whether the object nodes and/or user account nodes are similar or not.

According to some example embodiments, as shown in FIG. 4C, the two or more transformed time-dependent network graphs may be included in a projection, joined, and/or combined by the analysis server 132 to create a transformed graph for use in detecting outlying communities, etc., but the example embodiments are not limited thereto. For example, the transformed time-dependent network graph may further include additional connections, edges, and/or information between object nodes and/or account nodes, etc., such as similarity scores between two or more object nodes and/or account nodes, etc., but the example embodiments are not limited thereto. Moreover, for similarity connections between two or more nodes, a similarity connection between two or more user account nodes may include information related to the number of shared traded stocks between the connected user account nodes (e.g., “count”), the weight assigned to the account relationship as determined in FIG. 4B (e.g., “weight”), etc., and for similarity connections between two or more object nodes, a similarity connection between two or more object nodes may include information related to the number of user accounts which traded the connected object nodes (e.g., “count”), the weight assigned to the account relationship as determined in FIG. 4B (e.g., “weight”), etc.

Referring again to FIG. 3, in optional operation S3050, the analysis server 132 may filter the at least one transformed time-dependent network graph based on desired inputs. More specifically, the analysis server 132 may receive user inputs from an analyst, investigator, regulator, law enforcement officer, etc., related to desired filter parameters for filtering the time-dependent network graph, such as desired demographic information (e.g., a desired age range of users (e.g., senior citizens, etc.)), desired geographical areas of users, desired category of security (e.g., microcap stocks, etc.), desired category of transactions (e.g., stock sales, stock purchases, options transactions, etc.), desired time range, etc., but the example embodiments are not limited thereto.

In operation S3060, the analysis server 132 may perform network analysis on the at least one transformed time-dependent network graph and/or generate a cluster graph based on the results of the network analysis. More specifically, the analysis server 132 may execute community detection algorithms and/or sampling algorithms to detect clusters within the transformed time-dependent network graph(s). For example, the analysis server 132 may perform a Community Detection algorithm on the transformed time-dependent network graph to determine and/or identify subsets of connected nodes (e.g., clusters and/or communities) which are more densely connected to each other (e.g., nodes within a community are more densely connected to each other than nodes outside of the community, etc.) in comparison to the rest of the network, and/or in comparison to a network constructed at random. In addition, the analysis server 132 may use trained machine learning algorithms and/or neural networks to identify clusters and/or communities within the transformed time-dependent network graph(s) by performing a plurality of random traversals of the transformed graph (e.g., random walks, etc.), inputting the sequences of nodes forming the traversals into a neural network algorithm, and producing a vector representation of each node based on the random traversals of the transformed graph as an output of the neural network algorithm. The analysis server 132 may identify and/or determine the proximity of the nodes (e.g., the scalar distance between two vectors, etc.) in the network based on the vector representation of each node included in the transformed time-dependent network graph.

Once the clusters have been detected within the transformed time-dependent network graph and/or the cluster graph has been generated, the analysis server 132 may determine outlier clusters of nodes based on the size of the cluster, the degree of similarity and/or connectivity of nodes within the cluster, the degree of similarity and/or connectivity of the cluster with other clusters (e.g., the distance between the cluster and other clusters, etc.), the variety of securities being traded within the cluster, the variety of user accounts included in the cluster, the level of trading activity of the accounts included in the cluster, etc. Additionally, an analyst, investigator, regulator, law enforcement officer, etc., may visually analyze the cluster graph to determine outlier clusters as well.

For example, as shown in FIG. 4D, the analysis server 132 may visually represent detected communities in the cluster graph based on the results of the network analysis of the transformed time-dependent network graph(s), and may further visually highlight communities within the cluster graph which appear to be abnormal and/or suspicious. For example, the abnormal status of a community may be determined based on one or more abnormality parameters, such as the size of the cluster (e.g., smaller clusters being more likely to be abnormal in comparison to larger clusters), the distance of the cluster to other clusters (e.g., outlying clusters being more likely to be abnormal than clusters which are closer to other clusters), the number of stock nodes included in each cluster (e.g., clusters with a lower number of stocks being traded, such as a single stock being traded, are more likely to be abnormal than clusters with a larger number of stocks being traded), the degree of connectivity between clusters (e.g., clusters with a loose and/or low connectivity to other clusters are more likely to be abnormal), the percentage of user accounts included in the cluster belonging to a particular demographic and/or geographic region (e.g., the higher percentage of similar user accounts in the cluster the more likely the cluster is abnormal), the level of trading activity of the user accounts and/or the securities in the cluster (e.g., clusters which have a large percentage of user accounts who rarely trade are more likely to be abnormal), etc.

Once the analysis server 132 determines and/or detects outlier communities (e.g., suspicious communities, abnormal communities, etc.) within the cluster graph, the analysis server 132 may generate and transmit at least one fraud alert based on the determined and/or detected outlier communities. As an example, the analysis server 132 may generate at least one fraud alert by including the information associated with the nodes and/or transactions included in the outlier community, such as the information regarding the securities included in the outlier community, the user accounts included in the outlier community, the dates associated with the transactions included in the outlier community, etc. The analysis server 132 may then transmit the at least one fraud alert to fraud investigators associated with the online trading platform, law enforcement, and/or security regulators, etc., for further investigation and/or analysis of the potentially fraudulent trading activity. Additionally, the analysis server 132 may transmit messages to the users associated with the potentially fraudulent trading activity to inform the users that they may have been victims of a potentially fraudulent trading activity (e.g., a pump-and-dump scheme, etc.) to send educational information to the users to inform them on how to avoid being victims of potentially fraudulent schemes, and/or to request further information to assist in the investigation of the potentially fraudulent trading activity, such as questions regarding their motivations for making the trades in question, how they became aware of the securities in question, where they obtained information regarding the securities in question (e.g., social media accounts, websites, forums, etc.), but the example embodiments are not limited thereto.

According to some example embodiments, the analysis server 132 may also automatically search for external information associated with the securities included in the outlier communities on or around the dates and/or times of the potentially fraudulent transaction activity, such as media statements, reports, and/or press releases made by the microcap companies in question, SEC filings by the microcap companies, news stories regarding the microcap companies, social media posts from verified accounts for the microcap companies and/or corporate officers of the microcap companies, etc., which may provide a “natural” explanation for the abrupt change and/or deviation in trading activity for the outlier securities in question, but the example embodiments are not limited thereto. Additionally, the analysis server 132 may include the external information in the fraud alert messages transmitted to investigators, etc., but the example embodiments are not limited thereto.

While FIGS. 3 and 4A to 4D illustrate various methods for performing detect anomalous trading cohorts and/or potential artificial market manipulation in the price of co-traded securities, the example embodiments are not limited thereto, and other methods may be used and/or modifications to the methods may be used to perform the detection of artificial market manipulation and/or potential artificial market manipulation of the example embodiments.

This written description uses examples of the subject matter disclosed to enable any person skilled in the art to practice the same, including making and using any devices, systems, and/or non-transitory computer readable media, and/or performing any incorporated methods. The patentable scope of the subject matter is defined by the claims, and may include other examples that occur to those skilled in the art. Such other examples are intended to be within the scope of the claims.

What is claimed is:

1. A server, the server comprising:
a memory storing computer readable instructions; and
processing circuitry configured to execute the computer readable instructions to cause the server to,
receive a transaction dataset, the transaction dataset including a plurality of transactions for analysis, each transaction of the plurality of transactions associated with a user account involved in the transaction, a transaction object involved in the transaction, and transaction timestamp information corresponding to a time of occurrence of the transaction, the user account being one of a plurality of user accounts,
generate a first network graph based on the transaction dataset, the first network graph including object nodes and user account nodes representing each of the transactions of the transaction dataset,
transform the first network graph into at least one time-dependent transformed graph,
perform network analysis on the at least one time-dependent transformed graph, and
generate at least one potential fraud alert based on results of the network analysis.

2. The server of claim 1, wherein the processing circuitry is further configured to execute the computer readable instructions to cause the server to transform the first network graph into the at least one time-dependent transformed graph by:
determining object similarity scores associated with each object node of the first network graph using a weighting based on the transaction timestamp information; and
generating the at least one time-dependent transformed graph based on the determined object similarity scores.

3. The server of claim 2, wherein
the weighting of the determined object similarity scores includes using an exponential decay function; and
the processing circuitry is further configured to execute the computer readable instructions to cause the server to transform the first network graph into the at least one time-dependent transformed graph by:
generating the at least one time-dependent transformed graph based on the weighted object similarity scores.

4. The server of claim 1, wherein the processing circuitry is further configured to execute the computer readable instructions to cause the server to transform the first network graph into the at least one time-dependent transformed graph by:
determining account similarity scores associated with each account node of the first network graph using a weighting based on the transaction timestamp information; and
generating the at least one time-dependent transformed graph based on the determined account similarity scores.

5. The server of claim 4, wherein
the weighting of the determined account similarity scores includes using an exponential decay function; and
the processing circuitry is further configured to execute the computer readable instructions to cause the server to transform the first network graph into the at least one time-dependent transformed graph by:
generating the at least one time-dependent transformed graph based on the weighted account similarity scores.

6. The server of claim 1, wherein the processing circuitry is further configured to execute the computer readable instructions to cause the server to perform the network analysis on the at least one time-dependent transformed graph by:
sampling sequences of the at least one time-dependent transformed graph to determine a plurality of clusters of the at least one time-dependent transformed graph;
identifying at least one outlier cluster from the plurality of clusters based on at least one fraud indicator; and
generating the at least one potential fraud alert based on the identified at least one outlier cluster.

7. The server of claim 1, wherein the processing circuitry is further configured to execute the computer readable instructions to cause the server to perform the network analysis on the at least one time-dependent transformed graph by:
detecting communities within the at least one time-dependent transformed graph to determine a plurality of clusters of the at least one time-dependent transformed graph;
identifying at least one outlier cluster from the plurality of clusters based on at least one fraud indicator; and
generating the at least one potential fraud alert based on the identified at least one outlier cluster.

8. The server of claim 1, wherein the processing circuitry is further configured to execute the computer readable instructions to cause the server to:
filter the at least one time-dependent transformed graph based on desired demographic information associated with each user account node of the at least one time-dependent transformed graph; and
perform the network analysis on the filtered at least one time-dependent transformed graph.

9. The server of claim 1, wherein the server is further configured to execute the computer readable instructions to cause the server to:
receive at least one potential fraud alert trigger, the at least one potential fraud alert trigger indicating at least one of,
a price breach alert, a volume breach alert, a desired threshold gain/loss alert, a co-traded object alert, or any combinations thereof;
filter the transaction dataset based on the received at least one potential fraud alert trigger; and
generate the first network graph based on the filtered transaction dataset.

10. The server of claim 1, wherein the server is further configured to execute the computer readable instructions to cause the server to:
transmit the at least one potential fraud alert to at least one of the user account associated with the potential fraud alert, a fraud investigation service, a government agency, or any combinations thereof.

11. A method of operating a server, the method comprising:
receiving a transaction dataset, the transaction dataset including a plurality of transactions for analysis, each transaction of the plurality of transactions associated with a user account involved in the transaction, a transaction object involved in the transaction, and transaction timestamp information corresponding to a time of occurrence of the transaction, the user account being one of a plurality of user accounts;
generating a first network graph based on the transaction dataset, the first network graph including object nodes and user account nodes representing each of the transactions of the transaction dataset;
transforming the first network graph into at least one time-dependent transformed graph;
performing network analysis on the at least one time-dependent transformed graph; and
generating at least one potential fraud alert based on results of the network analysis.

12. The method of claim 11, wherein the transforming the first network graph into the at least one time-dependent transformed graph further includes:
determining object similarity scores associated with each object node of the first network graph using a weighting based on the transaction timestamp information; and
generating the at least one time-dependent transformed graph based on the determined object similarity scores.

13. The method of claim 12, wherein
the weighting the determined object similarity scores includes using an exponential decay function; and
the transforming the first network graph into the at least one time-dependent transformed graph further includes,
generating the at least one time-dependent transformed graph based on the weighted object similarity scores.

14. The method of claim 11, wherein the transforming the first network graph into the at least one time-dependent transformed graph further includes:
determining account similarity scores associated with each account node of the first network graph using a weighting based on the transaction timestamp information; and
generating the at least one time-dependent transformed graph based on the determined account similarity scores.

15. The method of claim 14, wherein
the weighting the determined account similarity scores includes using an exponential decay function; and
the transforming the first network graph into the at least one time-dependent transformed graph further includes,
generating the at least one time-dependent transformed graph based on the weighted account similarity scores.

16. The method of claim 11, wherein the performing the network analysis on the at least one time-dependent transformed graph further includes:
sampling sequences of the at least one time-dependent transformed graph to determine a plurality of clusters of the at least one time-dependent transformed graph;
identifying at least one outlier cluster from the plurality of clusters based on at least one fraud indicator; and
generating the at least one potential fraud alert based on the identified at least one outlier cluster.

17. The method of claim 11, wherein the performing the network analysis on the at least one time-dependent transformed graph further includes:
detecting communities within the at least one time-dependent transformed graph to determine a plurality of clusters of the at least one time-dependent transformed graph;
identifying at least one outlier cluster from the plurality of clusters based on at least one fraud indicator; and
generating the at least one potential fraud alert based on the identified at least one outlier cluster.

18. The method of claim 11, further comprising:
filtering the at least one time-dependent transformed graph based on desired demographic information associated with each user account node of the at least one time-dependent transformed graph; and
performing the network analysis on the filtered at least one time-dependent transformed graph.

19. The method of claim 11, further comprising:
receiving at least one potential fraud alert trigger, the at least one potential fraud alert trigger indicating at least one of,
a price breach alert, a volume breach alert, a desired threshold gain/loss alert, a co-traded object alert, or any combinations thereof;
filtering the transaction dataset based on the received at least one potential fraud alert trigger; and
generating the first network graph based on the filtered transaction dataset.

20. The method of claim 11, further comprising:
transmitting the at least one potential fraud alert to at least one of the user account associated with the potential fraud alert, a fraud investigation service, a government agency, or any combinations thereof.

21. A non-transitory computer readable medium storing computer readable instructions, which when executed by processing circuitry of a server, causes the server to:
receive a transaction dataset, the transaction dataset including a plurality of transactions for analysis, each transaction of the plurality of transactions associated with a user account involved in the transaction, a transaction object involved in the transaction, and transaction timestamp information corresponding to a time of occurrence of the transaction, the user account being one of a plurality of user accounts;
generate a first network graph based on the transaction dataset, the first network graph including object nodes and user account nodes representing each of the transactions of the transaction dataset;
transform the first network graph into at least one time-dependent transformed graph, perform network analysis on the at least one time-dependent transformed graph; and
generate at least one potential fraud alert based on results of the network analysis.

22. The non-transitory computer readable medium of claim 21, wherein the server is further caused to transform the first network graph into the at least one time-dependent transformed graph by:
determining object similarity scores associated with each object node of the first network graph using a first weighting based on the transaction timestamp information;
determining account similarity scores associated with each account node of the first network graph using a second weighting based on the transaction timestamp information, wherein the first weighting and the second weighting includes,
weighting the object similarity scores and the account similarity scores using an exponential decay function; and
generating the at least one time-dependent transformed graph based on the weighted object similarity scores and the weighted account similarity scores.
